(19) United States
(12) Patent Application Publication
(10) Pub. No.: US 2025/0121543 A1
(43) Pub. Date: Apr. 17, 2025

(54) INJECTION MOLDING APPARATUS WITH EJECTION MECHANISM

(71) Applicant: Shenzhen Fulian Fugui Precision Industry Co., Ltd., Shenzhen (CN)

(72) Inventors: WEN-HSIUNG WU, NEW TAIPEI CITY (TW); XIAO-HONG FAN, Shenzhen (CN); ZHENG-LI LI, Shenzhen (CN)

(73) Assignee: Shenzhen Fulian Fugui Precision Industry Co., Ltd., Shenzhen (CN)

(21) Appl. No.: 18/385,743

(22) Filed: Oct. 31, 2023

(30) Foreign Application Priority Data
Oct. 11, 2023 (CN) 202311315026.0

(51) Int. Cl. B29C 45/40

(52) U.S. Cl. CPC B29C 45/401

(57) ABSTRACT

An injection molding apparatus includes a first mold module, a second mold module, and an ejection mechanism. The second mold module is disposed on the first mold module. An injection chamber and a product chamber are formed between the first mold module and the second mold module. The ejection mechanism includes a main ejection assembly; a main ejection rod mounted to the main ejection assembly and passes through the first mold module; the central ejection assembly disposed in the main ejection assembly; and a central ejection rod mounted to the central ejection assembly and passes through the first mold module. After plastic in the injection chamber and the product chamber are cooled, a plastic product and an injection part connected to the plastic product are formed. Next, the central ejection assembly is lifted to separate the injection part from the plastic product by the central ejection rod.

### FIELD

The subject matter herein generally relates to injection molding apparatuses with ejection mechanisms.

### BACKGROUND

Injection molding apparatus has been widely used in the manufacturing industry to shape plastic into plastic products. The injection molding apparatus can inject plastic into the injection chamber between the male mold and the female mold, and then the plastic flows into the product chamber through the injection chamber. After the plastic is cooled, the plastic product is formed in the product chamber, and the injection part is formed in the injection chamber.

At this time, the injection molding apparatus can drive an ejection pin mechanism to separate the plastic product and the injection part from the mold, and then the plastic product and the injection part can be taken out of the injection molding apparatus. However, debris may be generated due to the plastic product separated from the injection part, and the debris may fall into the product chamber and affect the appearance of the plastic product.

In addition, in order to adjust the position of plastic injection into the product chamber, a channel module is generally inserted into the mold and connected to the product chamber through the injection channel in the channel module. However, the junction of the channel module and the product chamber may produce burrs on the plastic product, thereby affecting the appearance of the plastic product.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. It will be appreciated that for simplicity and clarity of illustration, where appropriate, reference numerals have been repeated among the different figures to indicate corresponding or analogous elements.

FIG. 1 is a schematic diagram illustrating an injection molding apparatus in accordance with a first embodiment of the present disclosure.

FIG. 2 and FIG. 3 are schematic diagrams illustrating operations of the injection molding apparatus in FIG. 1.

FIG. 4 is an exploded view illustrating an ejection mechanism and a pushing block in accordance with the first embodiment of the present disclosure.

FIG. 5 is a flow chart illustrating an operation method of the injection molding apparatus in accordance with an embodiment of the present disclosure.

FIG. 6 is a schematic diagram illustrating a first mold module, a second mold module, and a channel module in accordance with the first embodiment of the present disclosure.

FIG. 7 is an exploded view illustrating the channel module in accordance with the first embodiment of the present disclosure.

FIG. 8 is a schematic diagram illustrating the first mold module, the second mold module, and the channel module in accordance with a second embodiment of the present disclosure.

FIG. 9 is a schematic diagram illustrating the channel module and the first mold module in FIG. 8.

FIG. 10 is an exploded view illustrating the channel module in accordance embodiment of the second embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of embodiments and not by way of limitation in the figures of the accompanying drawings, in which like references indicate similar elements. It should be noted that references to “an” or “one” embodiment in this disclosure are not necessarily to the same embodiment, and such references mean “at least one.”

The term “connect” is defined as directly or indirectly through intervening components, and is not necessarily limited to physical connections. The connection can be such that the objects are permanently connected or releasably connected. The term “comprising,” when utilized, means “including, but not necessarily limited to;” it specifically indicates open-ended inclusion or membership in the so-described combination, group, series, and the like.

The present disclosure provides an injection molding apparatus that can reduce the debris falling into the product chamber during the separation process of the plastic product and the injection part. In addition, the injection molding apparatus of the present disclosure can reduce the burrs occurring on the plastic product near the connection of the channel module and the product chamber.

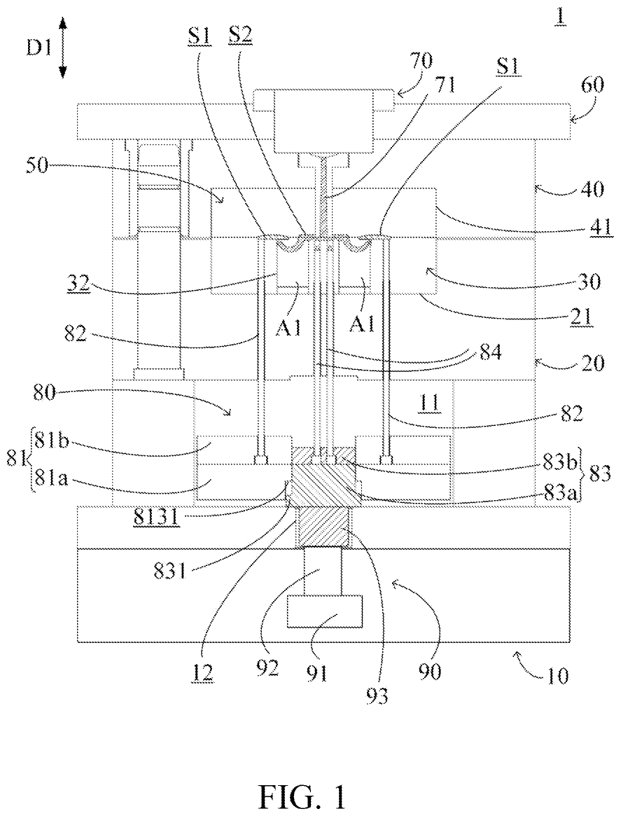

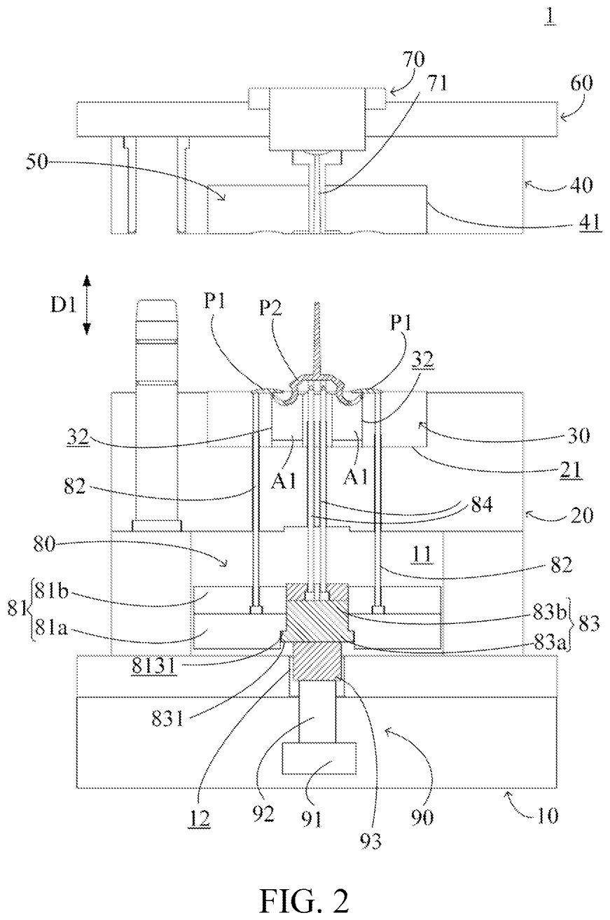

FIG. 1 is a schematic diagram of an injection molding apparatus 1 in accordance with a first embodiment of the present disclosure. FIG. 2 and FIG. 3 are schematic diagrams of the operations of the injection molding apparatus 1 of FIG. 1. The injection molding apparatus 1 is used to make the plastic to a plastic product P1 (as shown in FIG. 3). The injection molding apparatus 1 includes a base 10, a first mold 20, a first mold module 30, a second mold 40, a second mold module 50, and an upper frame 60. The base 10, the first mold 20, the first mold module 30, the second mold 40, the second mold module 50 and the upper frame 60 is arranged in a vertical direction D1 in sequence, and respectively extend perpendicular to the vertical direction D1.

In the embodiment, the base 10, the first mold 20, the first mold module 30, the second mold 40, the second mold module 50, and the upper frame 60 may be a plate-like structure. The widths of the first mold 20, the second mold 40, and the upper frame 60 may be the same or approximately the same. The widths can be measured in the same direction (horizontal direction), which is perpendicular to the vertical direction D1. In the present disclosure, the term “approximately the same” means a tolerance range from −10% to +10%, including the meaning of “the same”. The base 10, the first mold 20, the first mold module 30, the second mold 40, the second mold module 50, and the upper frame 60 are made of metal materials, such as steel.

The base 10 can be placed on a platform or on the ground. The first mold 20 is disposed on the base 10. In the embodiment, the first mold 20 is detachably affixed to the base 10. The first mold 20 is between the base 10 and the second mold 40. The first mold 20 includes a first receiving groove 21. The first mold module 30 is detachably disposed in the first receiving groove 21. The first mold module 30 can be replaced with another first mold module according to the shape of different plastic product P1.

The second mold 40 is disposed on the first mold 20. In the embodiment, the second mold 40 can selectively contact the first mold 20, or be separated from the first mold 20. The second mold 40 is between the first mold 20 and the upper frame 60. The second mold 40 has a second receiving groove 41. The second mold module 50 is detachably disposed in the second receiving groove 41, and corresponds to the first mold module 30. In other words, the second mold module 50 is disposed on the first mold module 30. The second mold module 50 can be replaced with another second mold module according to the shape of different plastic product P1. The second mold module 50 can selectively contact the first mold module 30, or be separated from the first mold module 30. When the second mold module 50 contacts the first mold module 30, a product chamber S1 and an injection chamber S2 are formed between the first mold module 30 and the second mold module 50, and the injection chamber S2 is in communication with product chamber S1.

In the embodiment, the first mold 20 may be a male mold, and the first mold module 30 may be a male mold module. The second mold 40 may be a female mold, and the second mold module 50 may be a female mold module. In another embodiment, the first mold 20 may be a female mold, and the first mold module 30 may be a female mold module. The second mold 40 may be a male mold, and the second mold module 50 may be a male mold module.

The upper frame 60 is disposed on the second mold 40. In the embodiment, the second mold 40 is detachably affixed to the upper frame 60.

The injection molding apparatus 1 further includes an injection device 70 and an ejection mechanism 80. The injection device 70 is used to inject the plastic into the product chamber S1. The ejection mechanism 80 is used to eject the plastic product P1, formed by the cooled plastic, out of the first mold module 30.

The injection device 70 is disposed on the upper frame 60. In the embodiment, the injection device 70 includes an injection tube 71. The injection tube 71 is disposed in the second mold 40 and the second mold module 50, and is connected to the injection chamber S2. The injection device 70 injects the plastic in the injection chamber S2 via the injection tube 71. Next, the plastic in the injection chamber S2 flows into the product chamber S1. After the plastic is cooled, the plastic in the product chamber S1 is to be the plastic product P1, and the plastic in the injection chamber S2 is to be the injection part P2. The injection part P2 is connected to the plastic product P1.

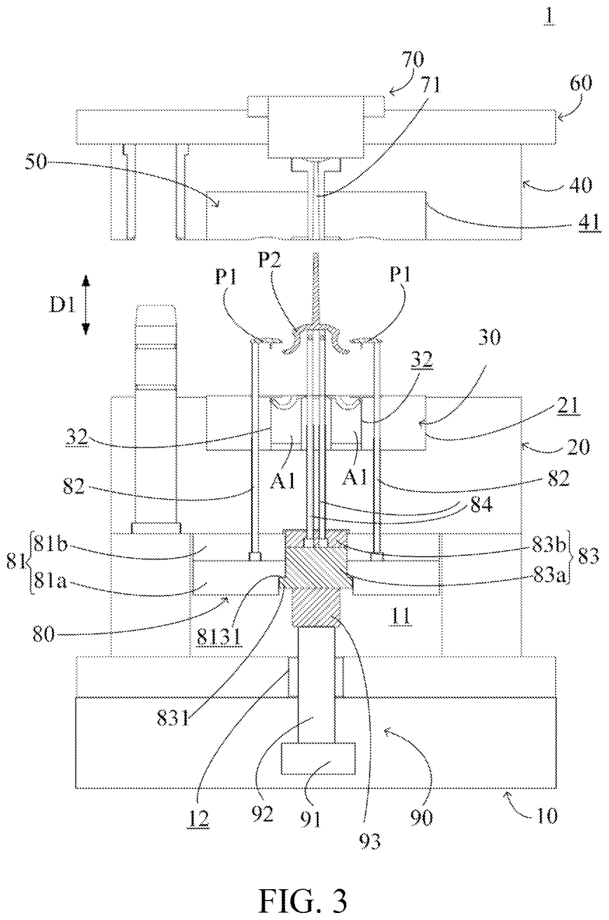

FIG. 4 is an exploded view of the ejection mechanism 80 and the pushing block 93 in accordance with the first embodiment of the present disclosure. The ejection mechanism 80 is disposed in the receiving space 11 of the base 10. The ejection mechanism 80 includes a main ejection assembly 81, main ejection rods 82, a central ejection assembly 83, and central ejection rods 84. The main ejection assembly 81 is a plate structure, extending perpendicular to the vertical direction D1. The main ejection assembly 81 is in the receiving space 11, and can be moved in the vertical direction D1 in the receiving space 11.

The main ejection assembly 81 includes a bottom surface 811, a top surface 812, a first restriction hole 813, and a second restriction hole 814. The bottom surface 811 faces the bottom of the receiving space 11, and the top surface 812 faces the first mold 20. The bottom surface 811 is parallel to the top surface 812, and extends perpendicular to the vertical direction D1. The first restriction hole 813 is formed on the central area of the bottom surface 811. The second restriction hole 814 is formed on the restriction surface 8131 of the first restriction hole 813, and formed on the area of the top surface 812. The first restriction hole 813 and the second restriction hole 814 extend in the vertical direction D1. In the embodiment, the width of the first restriction hole 813 is greater than the width of the second restriction hole 814. The first restriction hole 813 and the second restriction hole 814 may be a square in horizontal sections of the main ejection assembly 81.

The main ejection rods 82 are mounted to the main ejection assembly 81, and pass through the first mold 20 and the first mold module 30. The main ejection rods 82 may be parallel to each other, and extend in the vertical direction D1. In the embodiment, the ejection mechanism 80 includes eight main ejection rods 82, but it is not limited thereto. The ejection mechanism 80 may include at least two, three, or four main ejection rods 82.

In the embodiment, the main ejection assembly 81 includes a first ejection plate 81a and a second ejection plate 81b. The second ejection plate 81b is detachably affixed to the first ejection plate 81a. The first ejection plate 81a and the second ejection plate 81b are perpendicular to the vertical direction D1, and can be moved in the vertical direction D1 in the receiving space 11. The main ejection rods 82 pass through the second ejection plate 81b, and the main ejection rod 82 is affixed to the first ejection plate 81a by the second ejection plate 81b. Moreover, the first restriction hole 813 is formed on the first ejection plate 81a, and the second restriction hole 814 is formed on the first ejection plate 81a and the second ejection plate 81b.

The central ejection assembly 83 is disposed in the main ejection assembly 81. The central ejection assembly 83 may be a block structure, and extend in the vertical direction D1. The central ejection assembly 83 is in the first restriction hole 813 and the second restriction hole 814, and can be moved in the vertical direction D1 in the first restriction hole 813 and the second restriction hole 814. In other words, the central ejection assembly 83 is limited to be moved in the vertical direction D1 by the first restriction hole 813 and the second restriction hole 814. The central ejection assembly 83 includes lifting portions 831 disposed on at least two side surfaces of the central ejection assembly 83. In another embodiment, the central ejection assembly 83 includes one lifting portion 831 disposed on one side surface of the central ejection assembly 83. The lifting portions 831 are movably disposed in the first restriction hole 813, and may contact the side walls of the first restriction hole 813. In the embodiment, the greatest width of the central ejection assembly 83 with the lifting portions 831 is approximately the same the greatest width of the first restriction hole 813, and greater than the greatest width of the second restriction hole 814. The greatest widths are measured in the same direction, which is perpendicular to the vertical direction D1.

The central ejection rods 84 are mounted to the central ejection assembly 83, and pass through the first mold 20 and the first mold module 30. The central ejection rods 84 may be parallel to each other, and extend in the vertical direction D1. In the embodiment, the ejection mechanism 80 includes five central ejection rods 84, but it is not limited thereto. The ejection mechanism 80 includes at least one, two, or three central ejection rods 84.

In the embodiment, the central ejection assembly 83 includes a first ejection block 83a and a second ejection block 83b. The second ejection block 83b is detachably affixed to the first ejection block 83a. The first ejection block 83a and the second ejection block 83b can be moved in the vertical direction D1 in the first restriction hole 813 and the second restriction hole 814. The central ejection rods 84 pass through the second ejection block 83b, and the central ejection rods 84 are affixed to the first ejection block 83a by the second ejection block 83b. Moreover, the lifting portion 831 is disposed on the side wall of the first ejection block 83a. The widths of the first ejection block 83a and the second ejection block 83b are approximately the same as the width of the second restriction hole 814, and are less than the width of the first restriction hole 813. The greatest width of the first ejection block 83a and the lifting portion 831 is approximately the same as the greatest width of the first restriction hole 813, and is greater than the greatest width of the second restriction hole 814. The width is measured in the same direction, which is perpendicular to the vertical direction D1.

As shown in FIG. 1 to FIG. 3, the drive device 90 is disposed in the base 10, and is used to move the central ejection assembly 83 in the vertical direction D1. In the embodiment, the drive device 90 includes a motor 91, a drive rod 92, and a pushing block 93. The motor 91 can control the drive rod 92 to move in the vertical direction D1. The pushing block 93 is on the drive rod 92. The base 10 further includes a position groove 12 in communication with the receiving space 11. The pushing block 93 is movably disposed in the position groove 12, and can be moved out of the position groove 12 by the drive rod 92. The width of the pushing block 93 is the same or approximately the same the width of the position groove 12. In other words, the position groove 12 can limit the pushing block 93 to be moved in the vertical direction D1. In the embodiment, the pushing block 93 is affixed to the bottom of the central ejection assembly 83, and contacts the top of the drive rod 92.

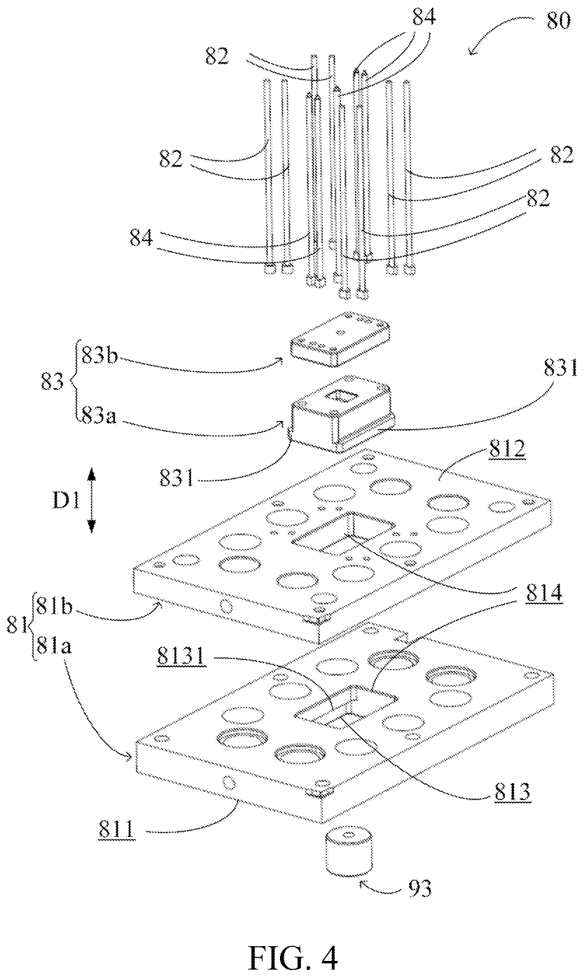

FIG. 5 is a flow chart of the operation method of the injection molding apparatus 1 in accordance with one embodiment of the present disclosure. In the step S10, as shown in FIG. 1, the second mold module 50 contacts the first mold module 30, and the product chamber S1 and injection chamber S2 are formed between the first mold module 30 and the second mold module 50. The injection device 70 injects plastic into the injection chamber S2, and the plastic in the injection chamber S2 flows into the product chamber S1. The ejection mechanism 80 is in an initial position in FIG. 1. When the ejection mechanism 80 is in the initial position, all of the pushing block 93 is in the position groove 12. The central ejection assembly 83 and the main ejection assembly 81 are in the bottom of the receiving space 11. The lifting portion 831 is separated from the restriction surface 8131. The main ejection rod 82 contacts the product chamber S1, and the central ejection rod 84 contacts the injection chamber S2.

In the step S20, as shown in FIG. 1 and FIG. 2, the injection molding apparatus 1 waits for the plastic to be cooled. After the plastic is cooled, the plastic in the injection chamber S2 forms the injection part P2, the plastic in the product chamber S1 forms the plastic product P1. Since the injection chamber S2 is in communication with the product chamber S1, the injection part P2 is connected to the plastic product P1.

In the step S30, as shown in FIG. 2, the second mold 40 and the second mold module 50 is lifted, so that the second mold module 50 is separated from the first mold module 30. At this time, the plastic product Pl and the injection part P2 are exposed from the first mold module 30.

In the step S40, as shown in FIG. 2, the drive device 90 lifts the central ejection assembly 83 to a predetermined position, so that the central ejection rods 84 move the injection part P2 to separate the injection part P2 from the plastic product P1. In other words, the connection of the injection part P2 and the plastic product P1 is broken, since the injection part P2 is lifted by the central ejection rod 84.

In the step S40, the drive rod 92 of the ejection mechanism 80 pushes the pushing block 93, so that the pushing block 93 protrudes over the position groove 12, and the lifting portion 831 contacts the restriction surface 8131. Since the lifting portion 831 is lifted, the central ejection assembly 83 and the central ejection rods 84 are lifted in the vertical direction D1. In other words, as shown in FIG. 1, in the initial position, the distance of the lifting portion 831 and the restriction surface 8131 is equal to the distance of lifting the central ejection rods 84. The lifted central ejection rods 84 pass through the injection chamber S2 of the first mold module 30, and lift the injection part P2 to make the connection of the injection part P2 and the plastic product P1 to be broken, and to separate the injection part P2 from the plastic product P1. In other words, the injection part P2 is separated from the plastic product P1 during lifting the central ejection assembly 83 from the initial position to the predetermined position.

In step S50, as shown in FIG. 3, the central ejection assembly 83 is continuously lifted until the ejection mechanism 80 is in a final position. In other words, the speed of the central ejection assembly 83 in the predetermined position is greater than 0 mm/s. The speed of the central ejection assembly 83 is greater than 0 mm/s during lifting the central ejection assembly 83 between the initial position lifts and the final position. In the embodiment, the distance of the predetermined position and the initial position is less than the distance of the final position and the predetermined position.

While continuing to lift the central ejection assembly 83 from the predetermined position in FIG. 2 to the final position, the lifting portion 831 of the central ejection assembly 83 pushes the restriction surface 8131 in the vertical direction D1, so that the central ejection assembly 83 further lifts the main ejection assembly 81. At this time, the central ejection rods 84 eject the injection part P2 in the injection chamber S2 of the first mold module 30, and remove the injection part P2 from the injection chamber S2 of the first mold module 30. The main ejection rods 82 pass through the product chamber S1 of the first mold module 30, and eject the plastic product P1 in the product chamber S1 of the first mold module 30, so as to remove the plastic product P1 from the product chamber S1 of the first mold module 30.

Through the injection molding apparatus 1 and the operation method of the injection molding apparatus 1 of this embodiment, the ejection movement of the main ejection assembly 81 and the main ejection rods 82 can be reduced, thereby reducing the volume of the injection molding apparatus 1. Moreover, before the plastic product P1 is separated from the product chamber S1 of the first mold module 30, the injection part P2 and the plastic product P1 are separated first, which can reduce the debris generated when the injection part P2 is separated from the plastic product P1 from falling into the product chamber S1 of the first mold module 30, thereby improving the appearance of plastic product P1.

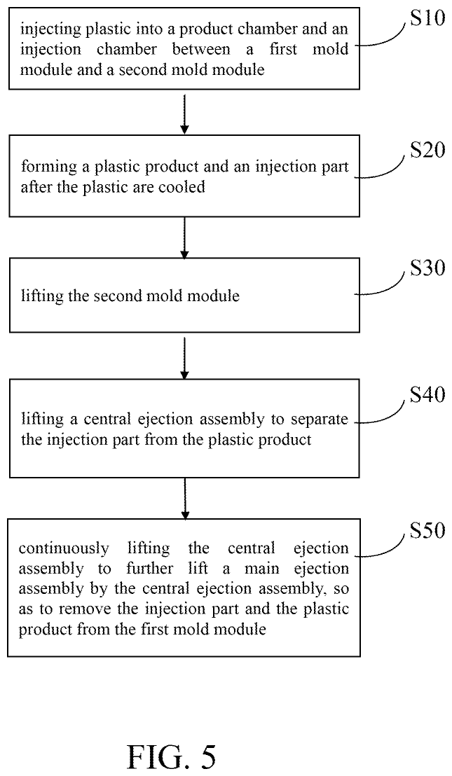

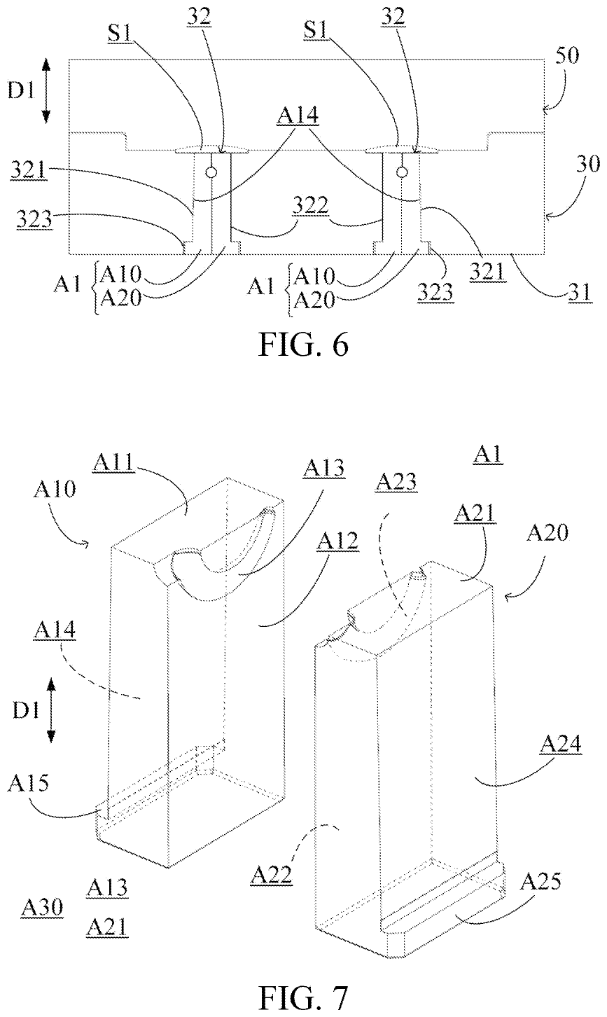

FIG. 6 is a schematic diagram of the first mold module 30, the second mold module 50, and the channel module A1 in accordance with the first embodiment of the present disclosure. The section presented in FIG. 6 is perpendicular to the sections presented in FIG. 1 to FIG. 3. FIG. 7 is an exploded view of the channel module A1 in accordance with the first embodiment of the present disclosure. The injection molding apparatus 1 further includes channel modules A1. The first mold module 30 further includes slots 32. As shown in FIG. 1 and FIG. 6, the injection molding apparatus 1 includes two channel modules A1, and the first mold module 30 includes two slots 32, but not limited thereto. The slots 32 are formed on the lower surface 31 of the first mold module 30. Each of the channel modules A1 is inserted into the slots 32 via the lower surface 31 of the first mold module 30.

The slot 32 includes a first side wall 321 and a second side wall 322. The first side wall 321 is opposite to the second side wall 322. In the embodiment, the first side wall 321 is inclined relative to the vertical direction D1. The second side wall 322 extends in the vertical direction D1. The first side wall 321 is inclined relative to the second side wall 322.

In the embodiment, the channel module A1 includes a first insertion module A10 and a second insertion module A20. The first insertion module A10 includes a first top surface A11, a first connection surface A12, a first injection groove A13, a first outer surface A14, and a first limit portion A15. The first connection surface A12 is connected to the first top surface A11, and extends perpendicular to the vertical direction D1. The first injection groove A13 is formed on the first connection surface A12, and is curved. The two ends of the first injection groove A13 are in communication with the first top surface A11. The first outer surface A14 is connected to the first top surface A11, and is inclined relative to the vertical direction D1. In the embodiment, the angle between the first outer surface A14 and the vertical direction D1 is in a range from 1 degree to 10 degrees. The angle between the first outer surface A14 and the vertical direction D1 is the same or approximately the same the angle between the first side wall 321 of the slot 32 and the vertical direction D1. The first limit portion A15 is disposed on the bottom of the first outer surface A14.

The second insertion module A20 includes a second top surface A21, a second connection surface A22, a second injection groove A23, a second outer surface A24, and a second limit portion 25. The second connection surface A22 is connected to the second top surface A21, and extends perpendicular to the vertical direction D1. The second injection groove A23 is formed on the second connection surface A22, and is curved. The two ends of the second injection groove A23 are in communication with the first top surface A11. When the first connection surface A12 is attached to the second connection surface A22, the first injection groove A13 and the second injection groove A23 form the injection channel A30. The injection channel A30 is a curved structure. When the channel module AT1 is inserted in the slot 32, the ends of the injection channel A30 are in communication with injection chamber S2 and the product chamber S1. Moreover, the ends of the injection channel A30 are in communication with the top surface (the first top surface A11 and the second top surface A21) of the channel module A1.

The second outer surface A24 is connected to the second top surface A21, and extends in the vertical direction D1. In other words, the second outer surface A24 is parallel to the second side wall 322 of the slot 32. The first outer surface A14 is inclined relative to the second outer surface A24. The second limit portion A25 is disposed on the bottom of the second outer surface A24. When first insertion module A10 and the second insertion module A20 are inserted into the slot 32, the first limit portion A15 and the second limit portion A25 are in the limit grooves 323 of the slot 32. The limit grooves 323 are on the bottom portion of the slot 32.

Due to the design of the channel module A1 and the slot 32 of this embodiment, when the channel module A1 is inserted upward into the slot 32 along the vertical direction D1, the channel module A1 can be more tightly inserted into the first mold module 30. Therefore, the probability of burrs on the surface of plastic product P1 is reduced, thereby improving the appearance of plastic product P1.

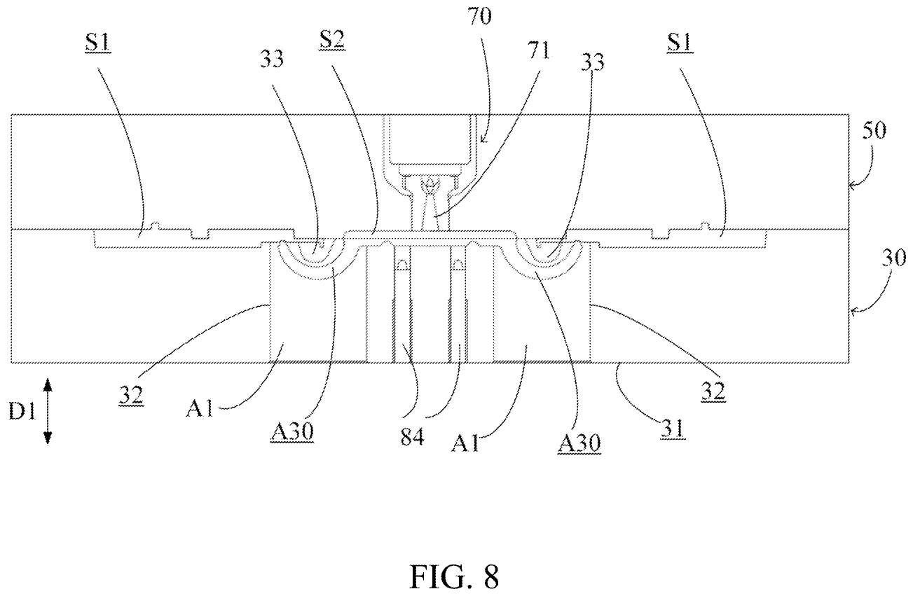

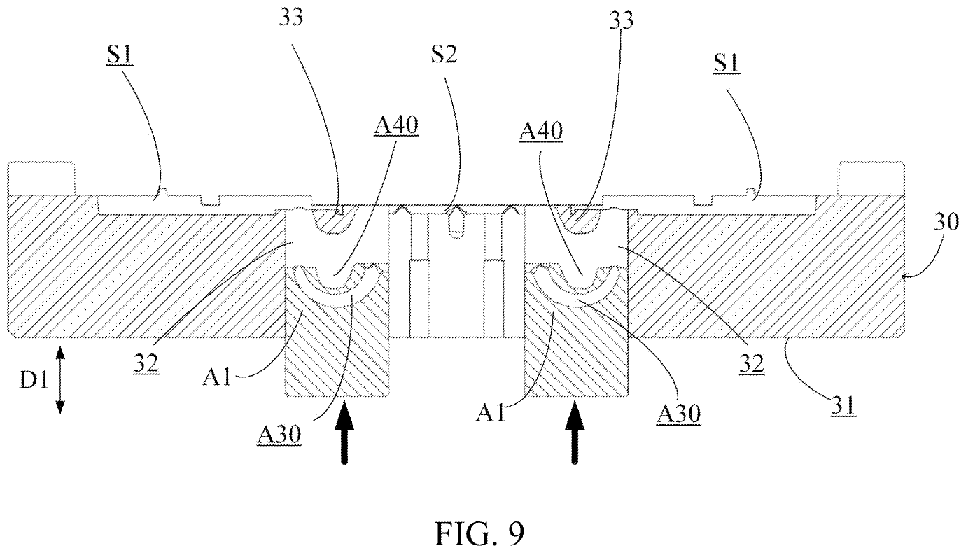

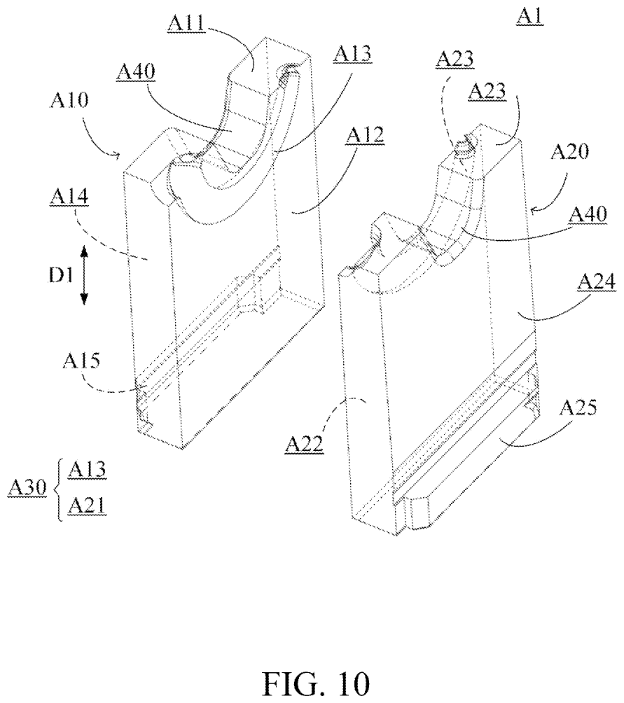

FIG. 8 is a schematic diagram of the first mold module 30, the second mold module 50, and the channel module A1 in accordance with a second embodiment. FIG. 9 is a schematic diagram of the channel module A1 and the first mold module 30 of FIG. 8. The cross section presented in FIG. 8 and FIG. 9 correspond to the cross section presented in FIG. 1 to FIG. 3. FIG. 10 is an exploded view of the channel module A1 in accordance embodiment of the second embodiment of the present disclosure.

In the second embodiment, an extension portion 33 of the first mold module 30 extends into the slot 32, and the product chamber S1 of the first mold module 30 extends into the extension portion 33. In the embodiment, the extension portion 33 may be separated from or at least one or two side walls of the slot 32. The channel module A1 further includes a notch A40 formed on the top surface (the first top surface A11 and the second top surface A21) of the channel module A1. The notch A40 is over the injection channel A30, and between two ends of the injection channel A30. Moreover, the notch A40 corresponds to the shape of the extension portion 33. After the channel module A1 is inserted into the slot 32, the extension portion 33 is in the notch A40, and the surface of the extension portion 33 attaches to the notch A40.

Through the notch A40 of the channel module A1 and the extension portion 33 of the first mold module 30, the connection position of the plastic product P1 and the injection part P2 can be adjusted to a place where the appearance of the plastic product P1 is not obvious, thereby improving the appearance of the plastic product P1.

Moreover, in the second embodiment, both of the first outer surface A14 and the second outer surface A24 of the channel module A1 are inclined relative to the vertical direction D1. The angle between the second outer surface A24 and the vertical direction D1 is in the range of 1 degree to 10 degrees. The distance of the top of the first outer surface A14 and the top of the second outer surface A24 is less than the distance of the bottom of the first outer surface A14 and the bottom of the second outer surface A24. The second side wall 322 (as shown in FIG. 6) of the slot 32 is inclined relative to the vertical direction D1.

In the present disclosure, through the channel module A1 and the slot 32, when the channel module A1 is inserted upward into the slot 32 in the vertical direction D1, the channel module A1 can be inserted more tightly into the first mold module 30 and reduce the burrs on the surface of plastic product P1, thereby improving the appearance of the plastic product P1.

Many details are often found in the relevant art, thus many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. An injection molding apparatus, comprising:
a first mold module;
a second mold module, disposed on the first mold module, wherein when the second mold module contacts the first mold module, an injection chamber and a product chamber are formed between the first mold module and the second mold module;
an ejection mechanism, comprising:
a main ejection assembly;
a main ejection rod mounted to the main ejection assembly, and passing through the first mold module;
a central ejection assembly disposed in the main ejection assembly; and
a central ejection rod mounted to the central ejection assembly, and passing through the first mold module; and
a drive device configured to move the central ejection assembly,
wherein after plastic in the injection chamber and the product chamber are cooled, a plastic product and an injection part connected to the plastic product are formed, and when the second mold module is separated from the first mold module, the drive device lifts the central ejection assembly to a predetermined position to separate the injection part from the plastic product by the central ejection rod, and
after the drive device lifts the central ejection assembly to the predetermined position, the central ejection assembly lifts the main ejection assembly to remove the injection part from the first mold module by the central ejection rod, and to remove the plastic product from the first mold module by the main ejection rod.

2. The injection molding apparatus as claimed in claim 1, wherein the main ejection assembly comprises a bottom surface, a first restriction hole formed on the bottom surface, and a second restriction hole,
the central ejection assembly is movably disposed in the first restriction hole and the second restriction hole, and the central ejection assembly comprising a lifting portion movably in the first restriction hole, and
after the drive device lifts the central ejection assembly to the predetermined position, the lifting portion pushes a restriction surface of the first restriction hole, so that the central ejection assembly lifts the main ejection assembly.

3. The injection molding apparatus as claimed in claim 1, further comprising:
a base comprising a receiving space, wherein the ejection mechanism is disposed in the receiving space;
a first mold disposed on the base, and comprising a first receiving groove, wherein the first mold module is disposed in the first receiving groove; and
a second mold disposed on the first mold, and comprising a second receiving groove, wherein the second mold module is disposed in the second receiving groove.

4. The injection molding apparatus as claimed in claim 3, wherein the base further comprises a position groove that is in communication with the receiving space, the drive device comprises a pushing block connected to the central ejection assembly, and
when the ejection mechanism is at an initial position, the pushing block is in the position groove, and when the ejection mechanism is at the predetermined position, the pushing block protrudes over the position groove.

5. The injection molding apparatus as claimed in claim 4, wherein the drive device further comprises:
a drive rod, wherein the pushing block is placed on the drive rod; and
a motor controlling the drive rod moving in a vertical direction.

6. The injection molding apparatus as claimed in claim 3, wherein the main ejection assembly comprises:
a first ejection plate; and
a second ejection plate detachably affixed to the first ejection plate, and movably in a vertical direction in the receiving space,
wherein the main ejection rod passes through the second ejection plate, and the main ejection rod is affixed to the first ejection plate by the second ejection plate.

7. The injection molding apparatus as claimed in claim 3, wherein the central ejection assembly comprises:
a first ejection block;
a second ejection block detachably affixed to the first ejection block, and movably in a vertical direction in the receiving space; and
a lifting portion disposed on a side wall of the first ejection block,
wherein the central ejection rod passes through the second ejection block, and the central ejection rod is affixed to the first ejection block by the second ejection block, and
after the drive device lifts the central ejection assembly to the predetermined position, the lifting portion lifts the main ejection assembly.

8. The injection molding apparatus as claimed in claim 1, further comprising a channel module, wherein the first mold module comprises a slot, the channel module is disposed in the slot, and the channel module comprises an injection channel,
wherein two ends of the injection channel are respectively in communication with the injection chamber and the product chamber.

9. The injection molding apparatus as claimed in claim 8, wherein the channel module further comprises a first outer surface and a second outer surface, and the first outer surface is inclined relative to the second outer surface.

10. The injection molding apparatus as claimed in claim 8, wherein the channel module further comprises a notch, the first mold module further comprises an extension portion in the notch, and the product chamber extends into the extension portion.

11. The injection molding apparatus as claimed in claim 8, wherein the channel module further comprises:
a first insertion module comprising a first top surface, a first connection surface connected to the first top surface, and a first injection groove formed on the first connection surface; and
a second insertion module comprising a second top surface, a second connection surface connected to the second top surface, and a second injection groove formed on the second connection surface,
wherein ends of the first injection groove are in communication with the first top surface, and ends of the second injection groove are in communication with the second top surface, and
when the first connection surface attaches to the second connection surface, the injection channel is formed by the first injection groove and the second injection groove.

12. The injection molding apparatus as claimed in claim 1, further comprising an injection device configured to inject the plastic into the injection chamber and the product chamber.

13. An operation method of an injection molding apparatus, comprising:
injecting plastic into a product chamber and an injection chamber in communication with the product chamber, wherein the product chamber and the injection chamber are located between a first mold module and a second mold module;
forming an injection part in the injection chamber by the plastic and forming a plastic product in the product chamber by the plastic after the plastic are cooled, wherein the injection part is connected to the plastic product;
lifting the second mold module to separate the second mold module from the first mold module;
lifting a central ejection assembly to move the injection part by a central ejection rod and to separate the injection part from the plastic product; and
continuously lifting the central ejection assembly to lift a main ejection assembly by the central ejection assembly, so that the injection part is removed from the first mold module by the central ejection rod, and the plastic product is removed from the first mold module by a main ejection rod.

14. The operation method as claimed in claim 13, wherein the main ejection assembly comprises a bottom surface, a first restriction hole formed on the bottom surface, and a second restriction hole formed on a restriction surface of the first restriction hole,
the central ejection assembly is movably disposed in the first restriction hole and the second restriction hole, and the central ejection assembly comprising a lifting portion movably in the first restriction hole, and
in continuously lifting the central ejection assembly, the lifting portion pushes the restriction surface to make the central ejection assembly to lift the main ejection assembly.

15. The operation method as claimed in claim 13, further comprising:
lifting the central ejection assembly from an initial position to a predetermined position by a drive device; and
continuously lifting the central ejection assembly from the predetermined position to lift the main ejection assembly to a final position by the central ejection assembly,
wherein a distance between the predetermined position and the initial position is less than a distance between the final position and the predetermined position.

16. The operation method as claimed in claim 14, wherein the injection part and the plastic product are separated during lifting the central ejection assembly from the initial position to the predetermined position, and a speed of the central ejection assembly at the predetermined position is greater than 0 mm/s.
